(19) United States
(12) Patent Application Publication
(10) Pub. No.: US 2002/0021049 A1
(43) Pub. Date: Feb. 21, 2002

(54) Protective circuit for a hard disk

(76) Inventor: Shih-Ping Yeh, Taipei (TW)

Correspondence Address: RABIN & CHAMPAGNE, P.C., Suite 500, 1101 14 Street, N.W., Washington, DC, 20005, US

(21) Appl. No.: 09/921,593

(22) Filed: Aug. 6, 2001

(30) Foreign Application Priority Data
Aug. 16, 2000 (TW) 89214196

(51) Int. Cl. H02B 1/24

(52) U.S. Cl. 307/116

(57) ABSTRACT

A hard disk protective circuit is arranged coupling with a hard disk drive (HDD) interface to become an extractable hard disk module. The protective circuit mainly comprises a rechargeable charge reservoir, a charge controller, and an automatic selectable switch, wherein the selectable switch is designed to switch power of the charge reservoir from a power terminal of the interface to the HDD to work as an uninterrupted power supply for moving a magnetic head of HDD to a specified parking zone safely and protecting the inside hard disks against damage.

### BACKGROUND OF THE INVENTION

This application incorporates by reference Taiwanese application Serial No. 89214196, filed Aug. 16, 2000.

### FIELD OF THE INVENTION

This invention relates generally to hard disk protective circuits, more particularly, it relates to a protective circuit capable of moving a magnetic head of hard disk drive to a specified parking zone in order not to destroy any data sector of hard disks in the case of improper operation of the hard disk drive.

### DESCRIPTION OF THE RELATED ART

Under normal conditions, a magnetic head of generic hard disk drive (HDD) is usually moved to a parking zone to prevent from being impacted after shutdown of the computer power.

However, in the case of a notebook computer, the HDD is commonly designed in form of an extractable hard disk module, or placed in a hard disk mobile rack and loaded in a desktop computer; hence, if the HDD is extracted out carelessly during working conditions, the magnetic head wouldn't be parked in due course in lack of electric power to therefore damage part of data sectors of the hard disks. The careless extraction of the HDD is especially frequent in a today's notebook computer, wherein installation of the HDD is made easily by taking advantage of two pieces of choking snaps.

### SUMMARY OF THE INVENTION

The primary object of this invention is to provide a hard disk protective circuit for moving a magnetic head of hard disk drive (HDD) to a parking zone so as to protect data sectors of hard disks against damage.

In order to realize the aforesaid object, a hard disk protective circuit of this invention is arranged coupling with a HDD interface to become an extractable hard disk module. The protective circuit mainly includes a rechargeable charge reservoir, a charge controller, and an automatic selectable switch, wherein the selectable switch is designed to switch power of the charge reservoir from a power terminal of the interface to the HDD to work as an uninterrupted power supply for moving a magnetic head of HDD to a specified parking zone safely and protecting the inside hard disks against damage.

For more detailed information regarding this invention together with further advantages or features thereof, at least an example of preferred embodiment will be elucidated below with reference to the annexed drawings.

### BRIEF DESCRIPTION OF THE DRAWINGS

The related drawings in connection with the detailed description of this invention, which is to be made later, are described briefly as follows, in which:

FIG. 1 indicates circuit composition of a protective circuit of this invention in a hard disk module;

FIG. 2 is a preferred embodiment of a charge controller of this invention;

FIG. 3 is a preferred embodiment of a selectable switch of this invention; and

FIGS. 4A, 4B, and 4C are waveform diagrams of the protective circuit of this invention.

### DETAILED DESCRIPTION OF THE PREFERRED EMBODIMENT

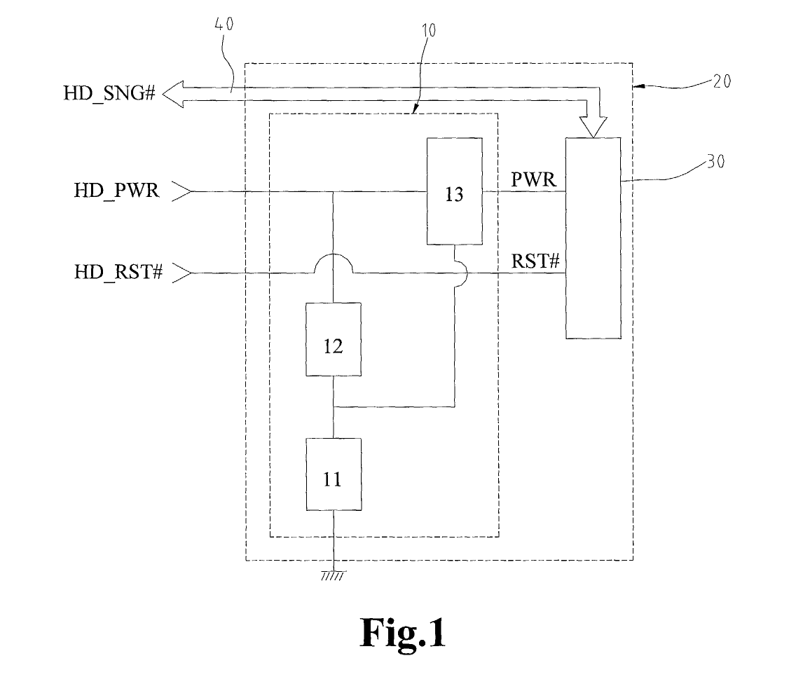

As indicated in FIG. 1, a hard disk protective circuit 10 of this invention is preferably combined with a hard disk drive (HDD) 30 to form a unitary hard disk module 20 in a generic computer for easy replacement of the module relative to a hard disk drive interface.

The hard disk protective circuit 10 basically includes a rechargeable charge reservoir 11, a charge controller 12, and a selectable switch 13. The HDD interface, such as an IDE (Integrated Drive Electronics) of industrial standard, usually includes a power terminal HD_PWR, a reset terminal HD_RST#, and a signal-control terminal HD_SNG# 40, etc, wherein the reset terminal HD_RST# is remained at a specified logic level, logic “high” for example, under normal operation; the power terminal HD_PWR is connected to the selectable switch 13 and serves as a power source to the charge reservoir 11; and the signal-control terminal 40 for output of control signals is coupled with the hard disk drive 30 of the hard disk module 20.

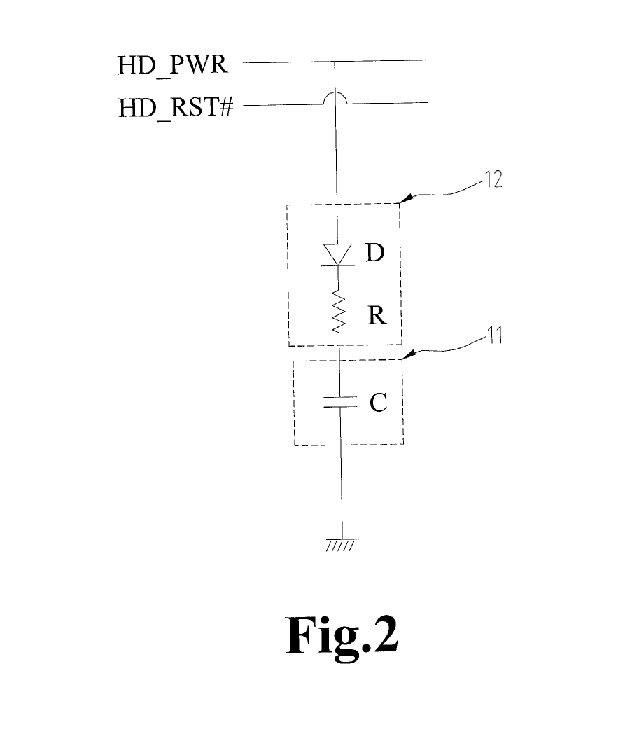

Practically, the charge controller 12 is optional depending on electrical characteristics of the charge reservoir 11. For example, when the charge reservoir 11 is a capacitor, the paired charge controller 12 is a capacitor charging circuit; or, a secondary battery (a Ni—Cd battery or a Lithium battery for instance) is paired with a secondary battery charging circuit (a known technique not to be reiterated here). In a preferred embodiment of this invention shown in FIG. 2, the charge reservoir 11 is a capacitor C with large capacitance, and the charge controller 12 comprises a diode D and a current limitation resistor R jointed in series.

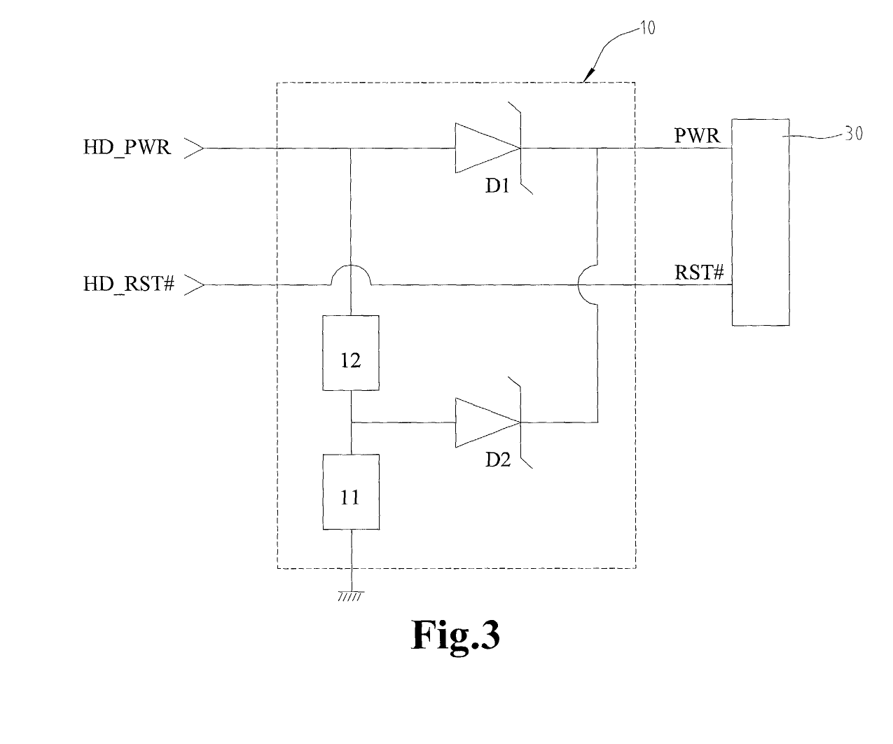

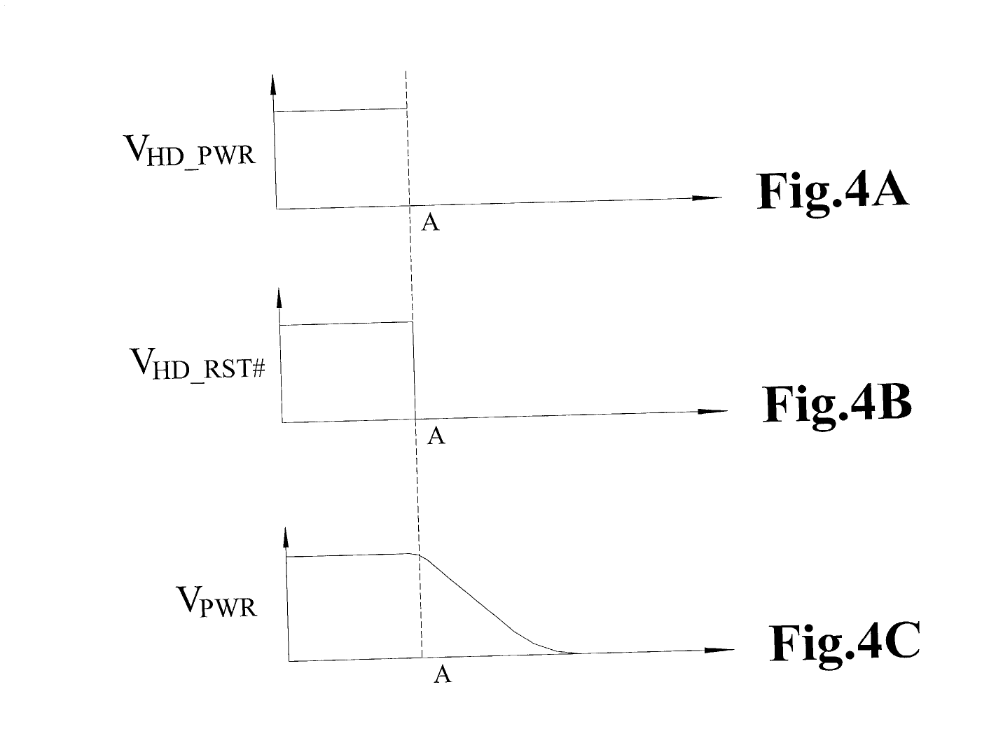

In a preferred embodiment of this invention shown in FIG. 3, the selectable switch 13 is composed of two Schottky diodes D1, D2, wherein the diode D1 is interposed between the HD_PWR terminal and a power end PWR of the hard disk drive (HDD) 30, the diode D2 between the charge reservoir 11 and the power end PWR. Under normal operation of a computer (not shown), voltage at the power terminal HD_PWR of the HDD interface is logic “high” and represented as VHD_PWR shown in FIG. 4A. Similarly, voltage at the reset terminal HD_RST# is also logic “high” and represented as VHD_RST# shown in FIG. 4B. In other words, under normal operation of the computer, the voltage at the VHD_PWR and VHD_RST#, terminal of the HDD interface and at the power end PWR of the HDD 30 are validated at logic “high” on left hand of a dotted line A shown in FIG. 4A through FIG. 4C. Meanwhile, the charge reservoir 11 is charged by the VHD_PWR through the charge controller 12.

When the hard disk module 20 is accidentally extracted out of the computer during operation, namely, power of the HDD 30 from the HD_PWR is cut off abruptly, then the charged power of the charge reservoir 11 will take the place of the disappeared HD_PWR in time to supply an tentative uninterrupted power supply VPWR to the HDD 30 shown on right hand of the dotted line A in FIG. 4C for moving the magnetic head of the HDD 30 to a due parking zone.

Moreover, the protective circuit for hard disk drive 10 of this invention is also applicable to a hard disk mobile rack of a generic desktop computer for the same purpose.

In addition, the protective circuit for hard disk drive 10 may be made in separate type to conductively joint with a HDD of a notebook computer to form a hard disk module comprising the protective circuit of this invention. In the above described, at least one preferred embodiment has been elucidated with reference to drawings annexed, it is apparent that numerous variations or modifications may be made without departing from the true spirit and scope thereof, as set forth in the claims below.

What is claimed is:

1. A protective circuit for a hard disk drive, which is conductively jointed with an interface situated between a hard disk drive and a computer, the protective circuit comprising:
a rechargeable charge reservoir;
a charge controller conductively connected to a power terminal HD_PWR of the hard disk drive for charging the charge reservoir; and
a selectable switch conductively connected with the charge reservoir for automatically switching power supply to the hard disk drive; wherein
the charge reservoir is switched automatically to provide power to the hard disk drive for parking the magnetic head thereof safely in case the hard disk drive is extracted improperly.

2. The protective circuit according to claim 1, wherein the rechargeable charge reservoir is a capacitor with large capacitance and the charge controller comprises a diode and a current limitation resistor jointed in series.

3. The protective circuit according to claim 1, wherein the rechargeable charge reservoir is a secondary Lithium battery and the charge controller is a charging circuit for the secondary Lithium battery.

4. The protective circuit according to claim 1, wherein the rechargeable charge reservoir is a secondary Ni—Cd battery and the charge controller is a charging circuit for the Ni—Cd battery.

5. The protective circuit according to claim 1, wherein the selectable switch comprises two Schottky diodes D1, D2.

6. The protective circuit according to claim 1, wherein the protective circuit is combined with the hard disk drive to form an extractable unitary hard disk module relative to the interface.

7. The protective circuit according to claim 6, wherein the extractable hard disk module is a hard disk mobile rack in a desktop computer.

8. The protective circuit according to claim 6, wherein the hard disk module is applicable in a notebook computer.
